(19) United States
(12) Patent Application Publication
(10) Pub. No.: US 2022/0060609 A1
(43) Pub. Date: Feb. 24, 2022

(54) CAMERA MODULE AND ELECTRONIC DEVICE

(71) Applicant: TRIPLE WIN TECHNOLOGY(SHENZHEN) CO.LTD., Shenzhen (CN)

(72) Inventors: SHIN-WEN CHEN, Tu-Cheng (TW); DING-NAN HUANG, New Taipei (TW); KE-HUA FAN, Shenzhen (CN); LONG-FEI ZHANG, Shenzhen,Guangdong (CN); KUN LI, Shenzhen (CN); SHENG-JIE DING, Shenzhen (CN)

(21) Appl. No.: 17/127,428

(22) Filed: Dec. 18, 2020

(30) Foreign Application Priority Data
Aug. 20, 2020 (CN) 202010844729.2

(51) Int. Cl. H04N 5/225; H04M 1/02

(52) U.S. Cl. CPC H04N 5/2253; H04N 5/2257; H04M 2250/52; H04M 1/0264; H04N 5/2254

(57) ABSTRACT

A camera module includes a circuit board, a mounting bracket disposed on the circuit board, an image sensor disposed on the circuit board and received in the mounting bracket, a first lens disposed in the mounting bracket, a driving mechanism disposed in the mounting bracket, and a second lens connected to the driving mechanism, and located between the image sensor and the first lens. The driving can drive the second lens to move between the first lens and the image sensor.

### FIELD

The subject matter herein generally relates to camera technology, especially to a camera module and an electronic device.

### BACKGROUND

At present, large lenses on the market usually have a fixed focal length. Such lens has a fixed depth of field, thus cannot be applied in different scenarios.

In order to realize the auto-focus function, a motor capable of adjusting a distance between the lens and an imaging surface is needed. However, when the lens is large in size, the motor may be difficult to be driven, and the cost of developing such motor may be also high. Furthermore, the motor for driving the large lens has a large volume, which is not beneficial to the miniaturization of the camera.

### BRIEF DESCRIPTION OF THE DRAWINGS

Implementations of the present disclosure will now be described, by way of embodiment, with reference to the attached figures.

FIG. 1 is a diagrammatic view of a camera module according to an embodiment of the present disclosure.

FIG. 2 is a cross-sectional view of the camera module taken along line II-II in FIG. 1.

FIG. 3 is a diagrammatic view of a driving mechanism of the camera module of FIG. 1.

FIG. 4 is a diagrammatic view of a second lens of the camera module of FIG. 1 moving downward.

FIG. 5 is a diagrammatic view of the second lens of the camera module of FIG. 1 moving upward.

FIG. 6 is a diagrammatic view of a method for manufacturing a camera module according to an embodiment of the present disclosure.

FIG. 7 is diagrammatic view of a camera module according to another embodiment of the present disclosure.

FIG. 8 is a diagrammatic of an electronic device according to an embodiment of the present disclosure.

### DETAILED DESCRIPTION

Implementations of the disclosure will now be described, by way of embodiments only, with reference to the drawings. It should be noted that the embodiments and the features of the present disclosure can be combined without conflict. Specific details are set forth in the following description to make the present disclosure to be fully understood. The embodiments are only portions of, but not all the embodiments of the present disclosure. Based on the embodiments of the present disclosure, other embodiments obtained by a person of ordinary skill in the art without creative efforts shall be within the scope of the present disclosure.

Unless defined otherwise, all technical and scientific terms used herein have the same meaning as commonly understood by one of ordinary skill in the art. The terms used herein in the specification of the present disclosure are only for describing the embodiments and are not intended to limit the present disclosure. The term “and/or” as used herein includes any combination of one or more related items.

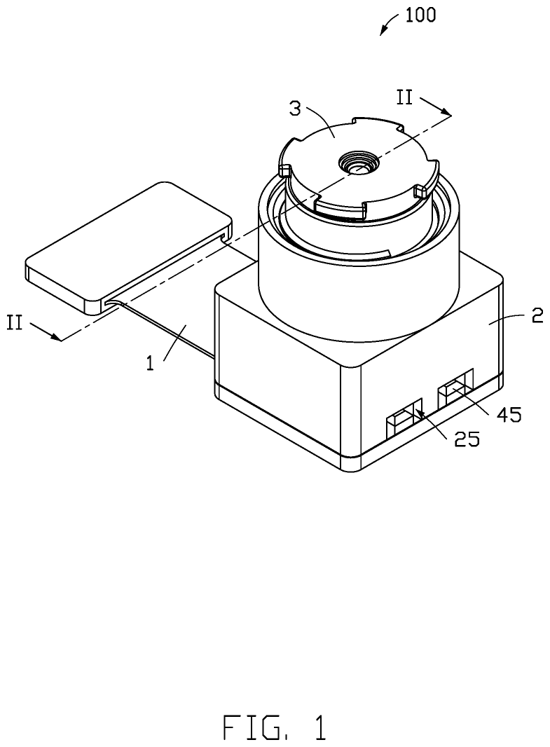

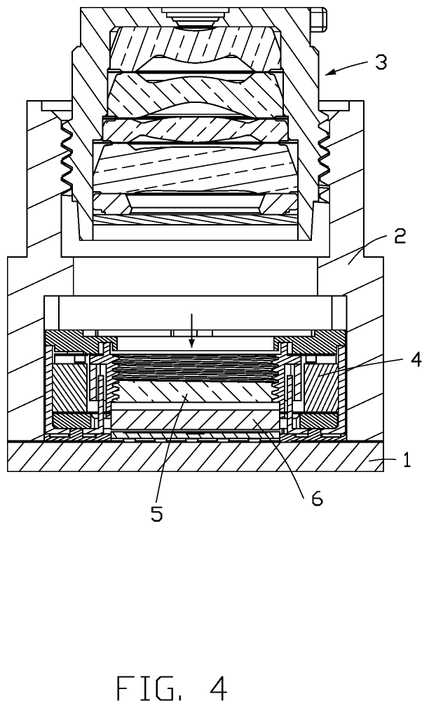

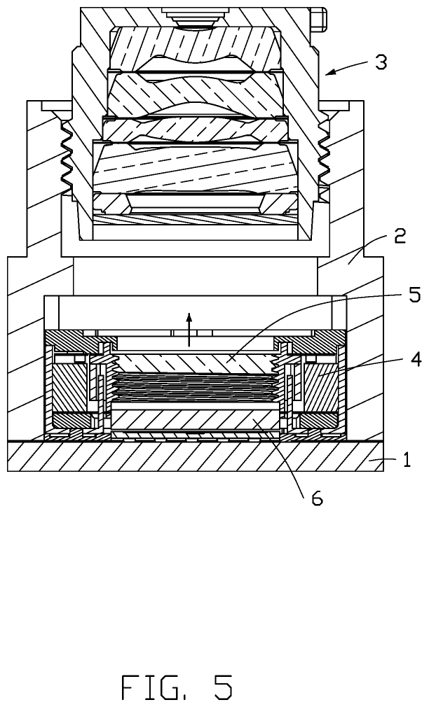

FIGS. 1-5 illustrate an embodiment of a camera module 100. The camera module 100 includes a circuit board 1, a mounting bracket 2 disposed on the circuit board 1, at least one first lens 3 disposed on the mounting bracket 2, a driving mechanism 4 received in the mounting bracket 2, a second lens 5 connected to the driving mechanism 4, and an image sensor 6 disposed on the circuit board 1 and received in the mounting bracket 2. The second lens 5 is located between the image sensor 6 and the first lens 3. The second lens 5 is driven by the driving mechanism 4 to move back and forth between the first lens 3 and the image sensor 6, thereby changing a focus position of the first lens 3.

The mounting bracket 2 includes a plurality of first sidewalls 21 and a plurality of second sidewalls 22 connected to the first sidewalls 21. The first sidewalls 21 cooperatively defines a first cavity 23. The second sidewall 22 cooperatively defines a second cavity 24. The first lens 3 is disposed in the first cavity 23. The second lens 5, the driving mechanism 4, and the image sensor 6 are disposed in the second cavity 24. An inner surface of the first sidewall 21 defines an internal thread. An outer surface of the first lens 3 defines an external thread matching the internal thread. Thus, the first lens 3 can be engaged with the first sidewall 21. An end portion of the second sidewall 22 away from the first sidewall 21 are connected to the circuit board 1 by a first adhesive layer 7.

In at least one embodiment, the mounting bracket 2 is integrally formed by injection molding.

In at least one embodiment, the first adhesive layer 7 is made of a light-shielding adhesive. External light can be prevented from entering the mounting bracket 2 through the first adhesive layer 7.

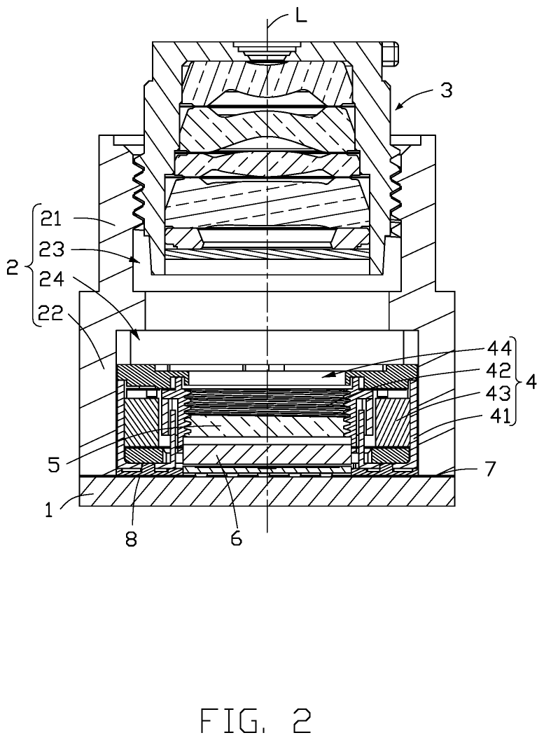

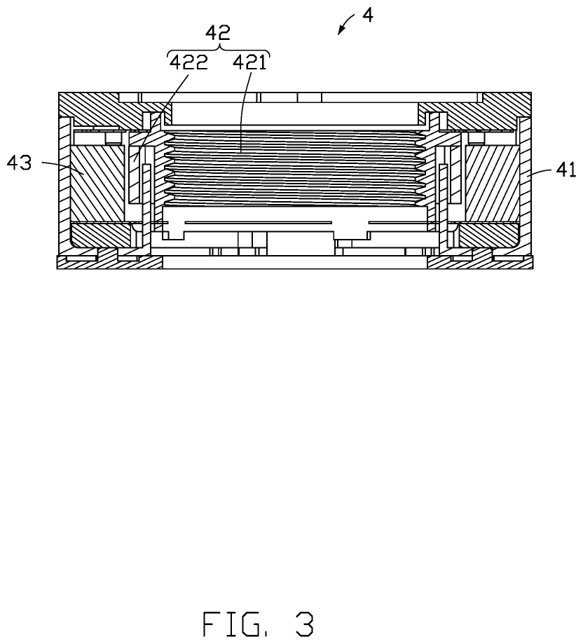

Referring to FIG. 3, the driving mechanism 4 is a voice coil motor. The voice coil motor includes a housing 41 and a movable assembly 42 movably received in the housing 41, and a magnet 43 located between the housing 41 and the movable assembly 42. The movable assembly 42 includes a movable frame 421 and a coil 422 wound around the movable frame 421. The second lens 5 is received in the movable frame 421. The magnet 43 and the coil 422 cooperatively generate an electromagnetic force to drive the movable assembly 42 to move. Thus, the second lens 5 moves between the first lens 3 and the image sensor 6 to change the focus position. The second lens 5 can be a convex lens. As shown in FIG. 2, the movable frame 421, the second lens 5, and the first lens 3 can have a same central axis L.

In at least one embodiment, the movable frame 421 defines a light-passing hole 44. The second lens 5 is received in the light-passing hole 44. Light passing through the first lens 3 and the second lens 5 is arrived at the image sensor 6.

In at least one embodiment, a sidewall of the light-passing hole 44 of the movable frame 421 defines an internal thread. An outer surface of the second lens 5 defines an external thread matching the internal thread. Thus, the movable frame 421 can be engaged with the second lens 5.

In at least one embodiment, the housing 41 of the driving mechanism 4 is bonded to the circuit board 1 by a second adhesive layer 8. The second adhesive layer 8 can also be made of a light-shielding adhesive. External light can be prevented from entering the mounting bracket 2 through the second adhesive layer 8.

Since the second lens 5 is located between the image sensor 6 and the first lens 3, that the second lens 5 can move between the first lens 3 and the image sensor 6 when driven by the driving mechanism 4, thereby adjusting the focus position. Therefore, an optimal imaging position can be achieved between the second lens 5 and the image sensor 6, which allows the camera module 100 to be applied in more scenarios. Furthermore, the second lens 5 for adjusting the focus position is independent from the first lens 3. Thus, the second lens 5 can be designed to be light in weight. The driving mechanism 4 does not need to drive the entire lens to move up and down, and thus the manufacturing cost of the driving mechanism 4 can be reduced.

Referring to FIG. 1, in at least one embodiment, the driving mechanism 4 further includes a wire 45 electrically connected to the coil 422. The mounting bracket 2 defines an opening 25. The wire 45 extends out of the housing 41 via the opening 25 to realize connection between the camera module 100 and an external power source (not shown).

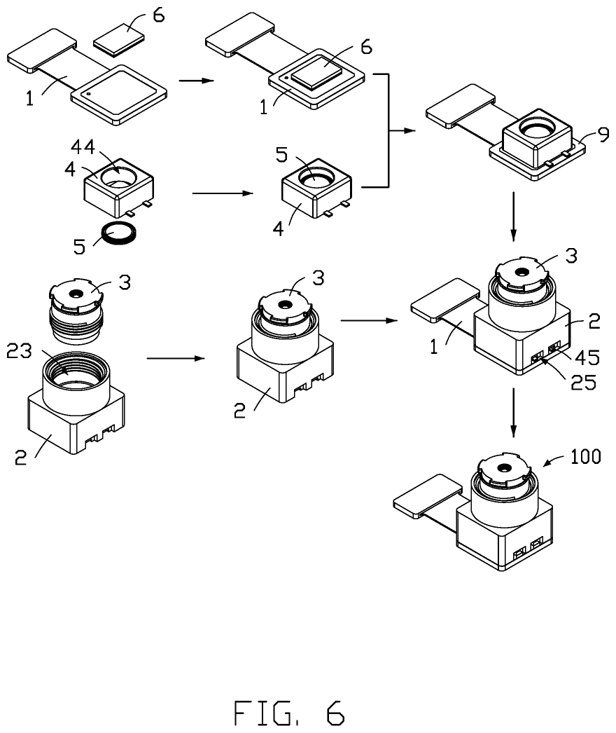

The camera module 100 can be manufactured by dividing a traditional lens assembly into the first lens 3 and the second lens 5. The second lens 5 can be a lens close to the image sensor 6. Then, the second lens 5 is connected to the drive mechanism 4. Referring to FIG. 6, a method for manufacturing the camera module 100 includes followings steps.

At step one, the image sensor 6 is mounted on the circuit board 1.

At step two, the second lens 5 is inserted into the light-passing hole 44 of the driving mechanism 4.

At step three, the drive mechanism 4 containing the second lens 5 is bonded to the circuit board 1 by the second adhesive layer 8, so that the image sensor 6 is located below the second lens 5. An intermediate product 9 is obtained.

At step four, the first lens 3 is connected to the mounting bracket 2.

At step five, the mounting bracket 2 containing the first lens 3 is assembled with the intermediate product 9, and is further bonded to the circuit board 1 through the first adhesive layer 7. Thus, the first lens 3 is located above the second lens 5. The wire 45 of the driving mechanism 4 extends out of the opening 25.

At step six, the wire 45 is soldered with tin thereon. Thus, the camera module 100 is obtained.

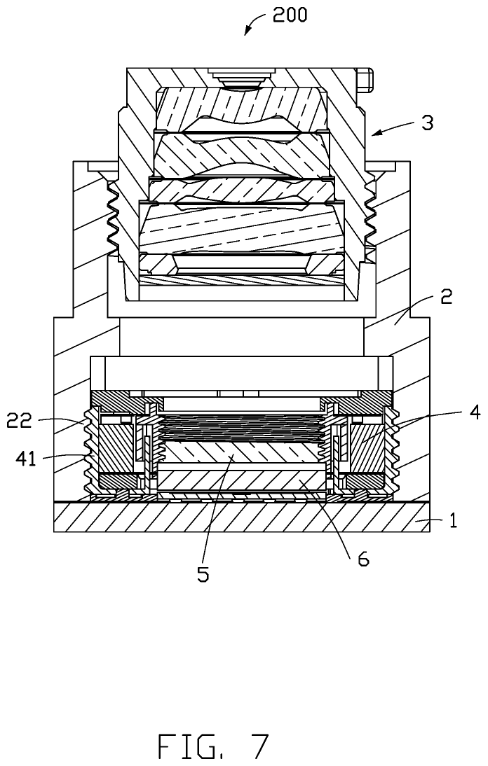

FIG. 7 illustrates another embodiment of a camera module 200. In the camera module 200, the driving mechanism 4 is installed on the inner surface of the mounting bracket 2.

In at least one embodiment, the inner surface of the second sidewall 22 is substantially cylindrical and defines an internal thread. The outer surface of the housing 41 of the driving mechanism 4 is substantially cylindrical and defines an external thread matching the internal thread. Thus, the housing 41 and the mounting bracket 2 can be engaged with each other. The driving mechanism 4 is directly mounted on the mounting bracket 2, to prevent the driving mechanism 4 from occupying the space of the circuit board 1, which is beneficial to the miniaturization of the camera module 200.

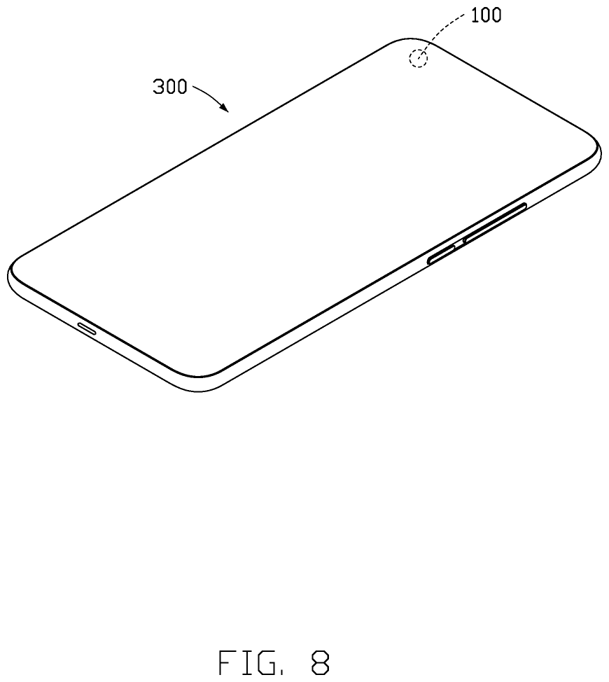

FIG. 8 illustrates an embodiment of an electronic device 300 including the camera module 100 (or the camera module 200). FIG. 8 shows that the electronic device 300 is a smart phone. In other embodiments, the electronic device 300 can also be a security monitor, a vehicle radar, a video machine, and so on.

Although the embodiments of the present disclosure have been shown and described, those having ordinary skill in the art can understand that changes may be made within the principles of the present disclosure, up to and including the full extent established by the broad general meaning of the terms used in the claims. It will, therefore, be appreciated that the embodiments described above may be modified within the scope of the claims.

1. A camera module, comprising:
a circuit board;
a mounting bracket disposed on the circuit board, the mounting bracket comprising a plurality of first sidewalls and a plurality of second sidewalls connected to the first sidewalls, the plurality of first sidewalls cooperatively defining a first cavity, the plurality of second sidewalls cooperatively defining a second cavity, a lateral width of the first cavity being less than a lateral width of the second cavity;
an image sensor disposed on the circuit board and received in the second cavity of the mounting bracket;
a first lens disposed in the first cavity of the mounting bracket;
a driving mechanism disposed in the second cavity of the mounting bracket; and
a second lens connected to the driving mechanism, and located between the image sensor and the first lens, the driving mechanism configured to drive the second lens to move between the first lens and the image sensor.

2. The camera module of claim 1, wherein the driving mechanism is a voice coil motor, the voice coil motor comprises a housing, a movable assembly movably received in the housing, and a magnet disposed between the housing and the movable assembly.

3. The camera module of claim 2, wherein the housing is fixed on the circuit board.

4. The camera module of claim 3, wherein the housing is fixed on the circuit board by an adhesive layer.

5. The camera module of claim 2, wherein the housing is fixed on an inner surface of the mounting bracket.

6. The camera module of claim 2, wherein the movable assembly comprises a movable frame and a coil wound around the movable frame, the second lens is received in the movable frame, the magnet and the coil cooperatively generate an electromagnetic force for driving the movable frame to move, causing the second lens to move between the first lens and the image sensor.

7. The camera module of claim 1, wherein the second lens is a convex lens.

8. An electronic device, comprising:
a camera module, comprising:
a circuit board;
a mounting bracket disposed on the circuit board, the mounting bracket comprising a plurality of first sidewalls and a plurality of second sidewalls connected to the first sidewalls, the plurality of first sidewalls cooperatively defining a first cavity, the plurality of second sidewalls cooperatively defining a second cavity, a lateral width of the first cavity being less than a lateral width of the second cavity;
an image sensor disposed on the circuit board and received in the mounting bracket;
a first lens disposed in the first cavity of the mounting bracket;
a driving mechanism disposed in the second cavity of the mounting bracket; and
a second lens connected to the driving mechanism, and located between the image sensor and the first lens, the driving mechanism configured to drive the second lens to move between the first lens and the image sensor.

9. The electronic device of claim 8, wherein the driving mechanism is a voice coil motor, the voice coil motor comprises a housing, a movable assembly movably received in the housing, and a magnet disposed between the housing and the movable assembly.

10. The electronic device of claim 9, wherein the housing is fixed on the circuit board.

11. The electronic device of claim 10, wherein the housing is fixed on the circuit board by an adhesive layer.

12. The electronic device of claim 9, wherein the housing is fixed on an inner surface of the mounting bracket.

13. The electronic device of claim 9, wherein the movable assembly comprises a movable frame and a coil wound around the movable frame, the second lens is received in the movable frame, the magnet and the coil cooperatively generate an electromagnetic force for driving the movable frame to move, causing the second lens to move between the first lens and the image sensor.

14. The electronic device of claim 8, wherein the second lens is a convex lens.
